(19) United States
(12) Patent Application Publication
(10) Pub. No.: US 2022/0298856 A1
(43) Pub. Date: Sep. 22, 2022

(54) Improved Methods of Manufacturing Flexible Screen Frames

(71) Applicant: FlexScreen LLC, Murrysville, PA (US)

(72) Inventor: Joseph A. Altieri, Jr., Pittsburgh, PA (US)

(21) Appl. No.: 17/617,228

(22) PCT Filed: Jun. 8, 2020
(86) PCT No.: PCT/US20/36701

§ 371 Date: Dec. 7, 2021

Related U.S. Application Data
(60) Provisional application No. 62/858,697, filed on Jun. 7, 2019.

(51) Int. Cl. E06B 9/52

(52) U.S. Cl. CPC E06B 9/52; E06B 2009/524

(57) ABSTRACT

A method for manufacturing a flexible screen frame from a flat wire having a coating includes bending the wire to substantially match the desired shape of the screen frame. The flat wire has a first end and a second end and the coating is removed from both ends to create bare wire portions that can be welded. A shrink tube is then slid onto the wire and moved away from the ends to be welded. Then, the ends are welded together and the shrink tube is used to cover the bare wire portions and the weld point. A screen mesh is then melted onto the frame.

### FIELD OF THE INVENTION

This application is an international application that claims priority from U.S. Provisional Application Ser. No. 62/858,697 entitled “Methods of Manufacturing Flexible Screen Frames” filed Jun. 7, 2019, the entire specification of which is incorporated by reference herein.

### BACKGROUND OF THE INVENTION

The present invention relates generally to methods of manufacturing window screens. More specifically, the present invention relates to a method for reducing costs associated with manufacturing flexible window and door screens.

Some window and door screen frames are fabricated from a single piece of material that is bent at appropriate locations to form desired dimensions for a particular window or door frame. By way of example, U.S. Pat. No. 9,234,388 to Altieri teaches that the entire screen frame can be fabricated from a single length of a material having spring-like characteristics and can be welded or otherwise connected in only a single spot, which may be at a corner or at some point along a side. As taught therein, wire coil is used to form the screen frame by means of manual or automatic machine wire forming and is welded in either the same or a secondary operation.

After forming the frame, Altieri teaches passing it through a cleaning, sealing, and rinse process and then drying it in an oven, which prepares it for powder coating. The formed frame is then run through a PVC powder coating process and is then cured in another oven. The coated frame then has screen mesh applied by means of manual or automatic welding either via an overlap weld, hem weld or butt weld with a hot air hot wedge or impulse welding process.

This previously disclosed process, however, has inherent drawbacks; powder coating the wire coil is not an easy process and can be quite expensive. Even with a skilled operator, inconsistencies, such as variances in the thickness of the finished product, can result in wasted effort and product. Powder coating lines require, among other things, a clean environment for the coating process, a large amount of space in the manufacturing warehouse, and high-flow gas lines. The process also generates wastewater that needs to be disposed of properly. What is needed is a method of producing a PVC-coated screen that removes the need for the expense and space of a powder coating line.

### BRIEF DESCRIPTION OF THE DRAWINGS

The accompanying drawings, which are incorporated in and form a part of the specification, illustrate the embodiments of the invention and together with the written description serve to explain the principles, characteristics, and features of the invention. In the drawings:

FIG. 1 a flowchart depicting an overview of the method of manufacturing a flexible screen frame for a window or door of the current invention.

FIG. 2 is a perspective view of a screen frame that has been bent into shape but has not yet been welded

FIG. 3 is a perspective view of a screen frame that has been welded and had a shrink tube applied.

FIG. 4 is a perspective view of a fully finished screen frame manufactured in a manner consistent with the current invention.

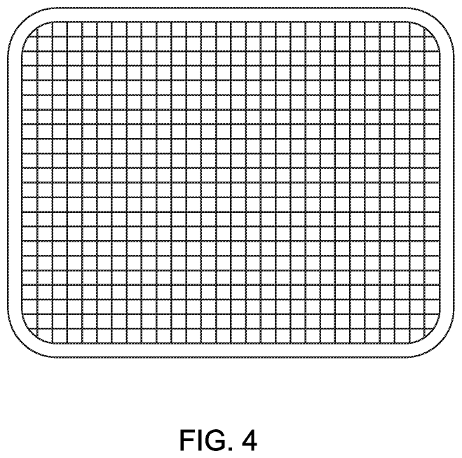

While implementations of the disclosed inventions are described herein by way of example, those skilled in the art will recognize that they are not limited to the embodiments or drawings described. It should be understood that the drawings and detailed description thereto are not intended to limit implementations to the particular form disclosed but, on the contrary, the intention is to cover all modifications, equivalents and alternatives falling within the spirit and scope as defined by the appended claims. The headings used herein are not meant to be used to limit the scope of the description or the claims.

### DETAILED DESCRIPTION OF THE INVENTION

In the following description, for purposes of explanation, numerous specific details are set forth in order to provide a thorough understanding of example embodiments. It will be evident to one skilled in the art, however, that embodiments can be practiced without these specific details. In some instances, well-known methods or components have not been described in detail so that the details of the present invention are not obfuscated.

In the interest of clarity, some routine features of the implementations described herein are omitted. It will be appreciated that in the development of any actual implementation of the present invention, certain decisions must be made in order to achieve specific goals, and that different decisions may be made to achieve different goals without departing from the teachings of the invention. While certain implementations might be complex and time-consuming, they would nevertheless be routine to accomplish for those of ordinary skill in the art having the benefit of this disclosure.

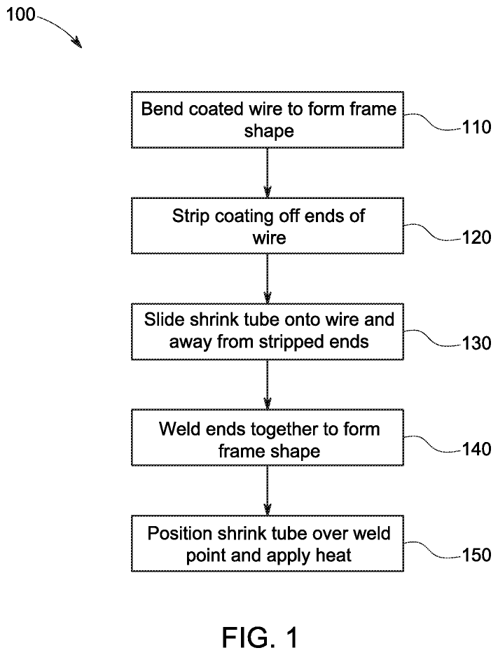

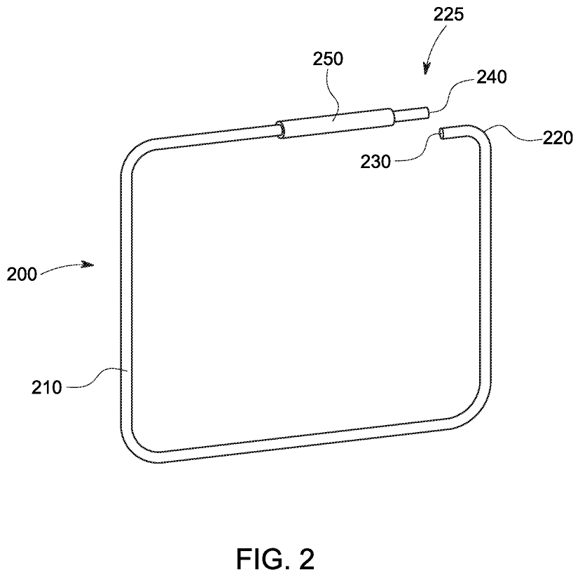

The present invention provides for a method of constructing a flexible screen for a window or door without the need for a powder-coating line in the manufacturing facility. With reference to FIG. 1, at step 110, a pre-coated flat steel wire is bent at appropriate dimensions to make a screen of a desired size. In certain embodiments, a flat steel wire having a width in the range of 0.09 inches to 0.156 inches and a thickness of approximately 0.225 inches, and which has been pre-coated with PVC or a similar thermoplastic coating, is bent at a nearly ninety-degree angle in four places to make a screen of a pre-determined size. With reference to FIG. 2, in certain other embodiments, four bends are made at predetermined locations in the flat wire 210 so that the weld point 225 where the first end 230 of the wire 210 and the second end 240 of the wire will meet is a sufficient distance away from the nearest corner 220. In embodiments, the weld point 225 is roughly six inches away from the corner 220. In this way, the frame that is ultimately created is structurally sound and the weld point is easy to conceal.

The next step 120 in the process is to strip the coating away from both the first end 230 and the second end 240 of the flat wire 210 so that the two ends 230, 240 can be welded together. Depending on the type of coating used, the stripping can be accomplished using heat, chemical reaction, or some other method known to those of skill in the art. In certain embodiments, only 1-2 inches of coating are stripped off the flat wire 210, which is enough to permit welding of the two ends 230, 240 together to form the frame 200.

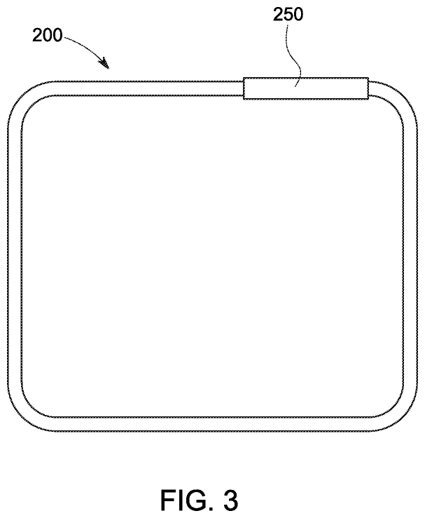

At step 130, a shrink tube 250 is slid onto the flat wire so that it is already on the frame 200 prior to the ends being welded together. The shrink tube 250 should be long enough to cover both of the stripped ends 230, 240. Next, at step 140, the two ends 230, 240 are welded together. Finally, at step 140, as illustrated by FIG. 3, the shrink-tube 250 is slid over to cover the weld point 225 and the portion of the wire that had been stripped and applied to the wire. Once in place, the shrink tube is heated, which causes it to constrict and conform to the frame 200 over the weld point 225. In embodiments, a ⅜″ inside diameter shrink tube is used and it may be heated using a heat gun, hot air, or placing on a conveyor and passing it through a heat chamber.

In certain embodiments, the shrink-tube 250 contains a layer of thermoplastic adhesive on its inner surface to create a good seal for keeping moisture out. As will be apparent to those of skill in the art, there are other types of shrink-tube than can be used and which do not have adhesive on the inner surface that can be used. Alternatively, the stripped and welded section of the screen frame 200 can be dipped into a melted coating that forms a bond with the metal as it known in the art. In embodiments, the shrink-tube 250 is an adhesive-lined polyolefin heat shrink tubing product.

Once the frame 200 is fully formed and the stripped portion and weld point have been covered by the shrink-tube, a screen mesh 400 is applied. In certain embodiments, the screen mesh 400 is fixedly attached to the screen frame 200. The mechanism of attachment is selected so that it is compatible with the mesh material and the frame material taking into consideration the environment in which the screen is to be used. Suitable means of attachment include, without limitation, melting, welding, adhesion, mechanical fastening, or other physical fixation. Welding techniques useful within the context of the present invention include thermal, chemical, radio frequency, electronic, frictional, and injection techniques. Examples of mechanical or physical fixation include adhesives (where the screen mesh is glued to the screen frame), tapes (where the screen mesh 400 is secured to the screen frame 200 using double-sided tape), mechanical fasteners (e.g., rivets, nails), or Velcro (with the male Velcro on the screen mesh and the female Velcro on the screen frame, or the converse) to bond the screen mesh to the frame. In certain embodiments, the screen mesh 400 may be folded over onto itself to form a loop. That loop may be sewed in place to form a pocket into which the screen frame 200 may be placed.

In certain embodiments, the screen mesh 400 and screen frame 200 are both coated in a thermoplastic, such as polyvinyl chloride (PVC), nylon, polyethylene, polypropylene, and polystyrene. In those embodiments, the screen mesh 400 and screen frame 200, including the previously-applied shrink tube, may be fused together into a single apparatus by melting the thermoplastic coating of each component while they are in contact with one another in a pre-selected shape and allowing the pieces to cool. After cooling, the two components are thus fused together into a single, unitary apparatus. The screen mesh 400 may be sized to fit against a face of the screen frame 200 or it may be sized to wrap partially or completely around one or more sides of the screen frame 200. The screen mesh 400 may also be sized so as to cover both sides of the screen frame 200.

In still other embodiments, identification information is printed on the shrink tube 250 prior to application for purposes of identification. Information such as account name, screen size, product type, warranty information, and other information can be printed on the exterior surface of the shrink tube. In embodiments, the print is 0.25 inches high, although the font could be larger or small depending on the need.

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure as come within known or customary practice in the art to which these teachings pertain.

1. A method of manufacturing a flexible screen having a frame with a desired shape and a screening mesh having a coating, the frame further constructed from a flat wire having a coating, the method comprising:
bending the wire to substantially match the desired shape; the wire having a first end and a second end;
removing the coating from the first end and the second end to create bare wire portions adjacent the ends;
sliding a shrink tube onto the wire and moving it away from the ends;
welding the ends together at a weld point to complete the desired shape;
positioning the shrink tube over the bare wire portions and the weld point;
heating the shrink tube to cause it to seal to the wire; and
bonding the screening mesh coating to the flat wire coating and the shrink tube.

2. (canceled)

3. The method of claim 1, wherein bonding the screening mesh further comprises placing the screening mesh in position on the frame and heating the screening mesh, the shrink tube, and the coating on the frame until they melt together.

4. The method of claim 1, wherein the flat wire is comprised of spring steel.

5. The method of claim 1, wherein the coating is comprised of a thermoplastic material.

6. The method of claim 5, wherein the thermoplastic material is one of the following:
PVC, nylon, polyethylene, polypropylene, and polystyrene.

7. The method of claim 1, wherein the shrink tube has an inner surface that makes contact with the frame, the inner surface having a thermoplastic adhesive for sealing with the frame.

8. The method of claim 1, wherein the desired shape has a plurality of corners and the weld point is located between four and eight inches from any of the plurality of corners.

9. The method of claim 1, wherein the bare portions extend in the range of one to two inches from the first end and the second end.

10. The method of claim 1, wherein the shrink tube contains printed information regarding one or more of sizing, account name, product type and warranty information.
